(19) United States
(12) Patent Application Publication
(10) Pub. No.: US 2010/0012057 A1
(43) Pub. Date: Jan. 21, 2010

(54) CYLINDER HEAD STRUCTURE FOR INTERNAL COMBUSTION ENGINE

(75) Inventors: Hidetoshi KITAGAWA, Toyota-shi (JP); Nobuyuki Murakami, Toyota-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/502,604

(22) Filed: Jul. 14, 2009

(30) Foreign Application Priority Data
Jul. 16, 2008 (JP) 2008-184998

(51) Int. Cl. F01P 1/00; F02F 1/42

(52) U.S. Cl. 123/41.56; 123/193.5

(57) ABSTRACT

In a cylinder head structure for an internal combustion engine that directs air into a covered space above the cylinder head covered by a head cover to ventilate the covered space, a gas flow passage space that extends continuously over an entire length or substantially over the entire length in a longitudinal direction is formed in the covered space. In addition, an air introduction position is provided within the gas flow passage space, and an air discharge position is provided outside the gas flow passage space.

### INCORPORATION BY REFERENCE

The disclosure of Japanese Patent Application No. 2008-184998 filed on Jul. 16, 2008 including the specification, drawings and abstract is incorporated herein by reference in its entirety.

### BACKGROUND OF THE INVENTION

1. Field of the Invention

The invention relates to a cylinder head structure for an internal combustion engine that directs air into a covered space above a cylinder head covered with a head cover to ventilate the covered space.

2. Description of the Related Art

For example, in Japanese Patent Application Publication No. 2007-71040 (JP-A-2007-71040), describes an internal combustion engine that uniformly directs air into the space above a cylinder head covered with a head cover to prevent degradation of lubricating oil from by blow-by gas that flows into out to the region above the cylinder head. In JP-A-2007-71040, a dam for defining a chain case side is formed, and a region above this dam is used as a throttle passage for air. The amount of air flowing into a space on the chain case side from the cylinder head side is thereby adjusted. Thus, an attempt is made to uniformly spread air under the head cover.

However, it is difficult to uniformly spread air directed into the space above the cylinder head simply by providing the dam between the cylinder head side and the chain case side. That is, the flow of air directed into the space above the cylinder head is not sufficiently taken into account. Therefore, the air flowing through the space above the cylinder head may stagnate. At a position where the airflow thus stagnates, blow-by gas flowing out from the chain case side or the like is accumulated in the stagnant gas to maintain a high concentration state. As a result, a degradation of the lubricating oil flowing along the surface of the cylinder head may be promoted. Thus, there are demands for a positive method of uniformly spreading air through the space above the cylinder head.

### SUMMARY OF THE INVENTION

The invention provides a cylinder head structure for an internal combustion engine that uniformly spreads air in a covered space above a cylinder head covered by a head cover by taking a flow passage of air into account.

A cylinder head structure for an internal combustion engine according to a first aspect of the invention is a cylinder head structure for an internal combustion engine that directs air into a covered space above a cylinder head covered by a head cover to ventilate the covered space. A gas flow passage space is formed in the covered space that extends continuously over an entire length or substantially over the entire length of the cylinder head in a longitudinal direction of the cylinder head. An air introduction position is formed in the gas flow passage space, and an air discharge position is formed outside of the gas flow passage space.

As described above, the gas flow passage space to extend continuously over the entire length or substantially over the entire length in the longitudinal direction in the covered space is formed. Thus, air directed into the covered space from the air introduction position in the gas flow passage space immediately flows quickly through the gas flow passage space, which exhibits particularly low flow resistance, and uniformly spreads in the entire gas flow passage space in the longitudinal direction. After that, although no special space for causing gas to flow is formed from this gas flow passage space in a lateral direction, air flows among various components arranged or formed on a surface of the cylinder head, and is eventually discharged to the outside of the covered space from the air discharge position located outside the gas flow passage space.

As described above, air evenly flows in the gas flow passage space, which exhibits particularly low flow resistance. Therefore, air first spreads substantially uniformly and sufficiently in the entire gas flow passage space. Air then starts flowing out from this entire gas flow passage space to other regions of the covered space. In this case, air flows in the lateral direction and hence covers a relatively short distance to sufficiently flow through the entire covered space above the cylinder head. Accordingly, air substantially uniformly spreads in the entire covered space. Thus, air reaches corner portions of the space and the like as well and can be prevented from stagnating.

By taking the flow passage of air into account as described above, air can be uniformly spread in the covered space above the cylinder head covered by the head cover.

A cylinder head structure for an internal combustion engine according to a second aspect of the invention is a cylinder head structure for an internal combustion engine that directs air into a covered space above a cylinder head covered by a head cover to ventilate the covered space. A gas flow passage space is formed in the covered space that extends discontinuously in a lateral direction and over an entire length or substantially over the entire length of the cylinder head in a longitudinal direction of the cylinder head. An air introduction position is formed in the gas flow passage space, and an air discharge position is formed outside of the gas flow passage space.

In the construction described above, the gas flow passage space extends discontinuously in the lateral direction but is formed over the entire length or substantially over the entire length in the longitudinal direction. Thus, air directed into a region of the gas flow passage space from the air introduction position quickly spreads in the entirety of this region of the gas flow passage space, then flows out from the gas flow passage space, covers a relatively short distance to flow among various components arranged or formed on a surface of the cylinder head, and again flows into another region of the gas flow passage space that is discontinuously separated from that region in the lateral direction. Air then quickly spreads in the entirety of this region of the gas flow passage space. Through repetition of this process, air relatively quickly spreads in all the regions of the gas flow passage space. At the same time, while flowing among the regions of the gas flow passage space, air spreads to a certain extent in the lateral direction as well.

Furthermore, air flows among the respective components arranged or formed on the surface of the cylinder head in the lateral direction from inside all the regions of the gas flow passage space, and is eventually discharged to the outside of the covered space from the air discharge position.

As described above, air evenly spreads in all the regions of the gas flow passage space, which exhibit particularly low flow resistance, in the longitudinal direction, flows out from all the discontinuously arranged regions of the gas flow passage space as well in the lateral direction, and covers a sufficiently short distance to flow through the entire covered space above the cylinder head. Thus, air sufficiently reaches corner portions of the covered space and the like as well and can be prevented from stagnating.

As described above, the gas flow passage space is arranged over the entire length or substantially over the entire length in the longitudinal direction, and extends discontinuously in the lateral direction. Air can thereby be uniformly spread in the covered space above the cylinder head covered with the head cover while maintaining a high degree of freedom in the design of the internal combustion engine.

### BRIEF DESCRIPTION OF THE DRAWINGS

The foregoing and/or further objects, features and advantages of the invention will become more apparent from the following description of example embodiments with reference to the accompanying drawings, in which like numerals are used to represent like elements and wherein:

FIG. 1 is a plan view showing an overall construction of a cylinder head for an internal combustion engine according to the first embodiment of the invention;

FIG. 2 is a cross-sectional view taken along a line X-X of FIG. 1;

FIG. 3 is a plan view showing an overall construction of a cylinder head for an internal combustion engine according to the second embodiment of the invention;

FIG. 4 is a plan view showing an overall construction of a cylinder head for an internal combustion engine according to the third embodiment of the invention;

FIG. 5 is a plan view showing an overall construction of a cam carrier according to the fourth embodiment of the invention; and

FIG. 6 is a cross-sectional view taken along a line Y-Y of FIG. 5.

### DETAILED DESCRIPTION OF EMBODIMENTS

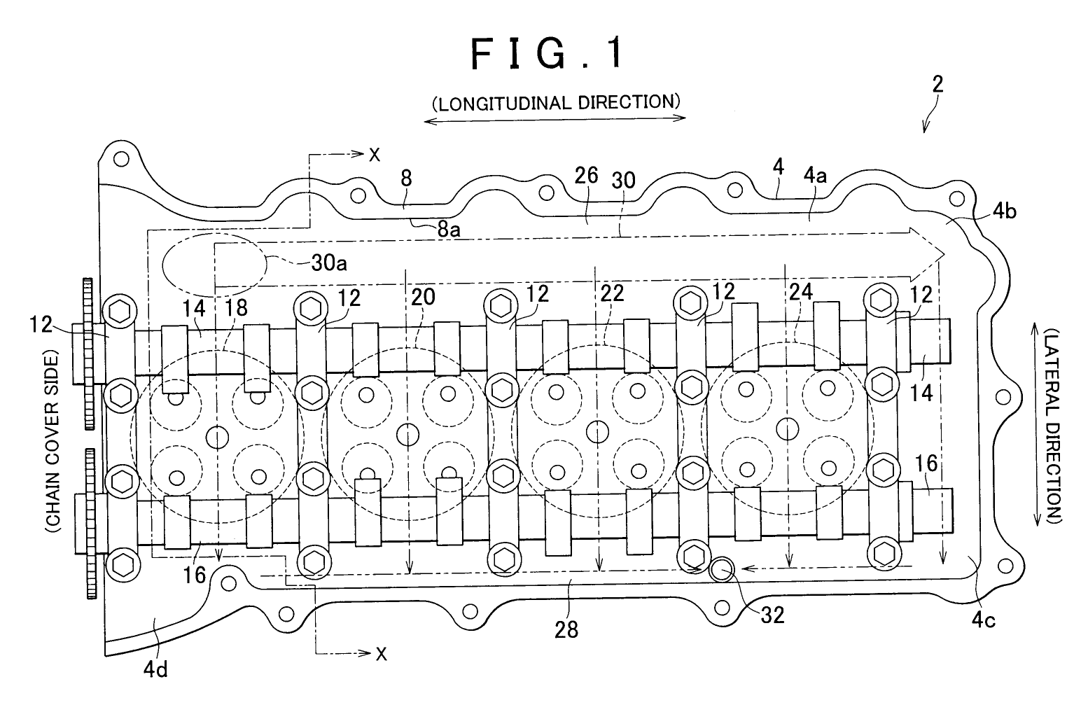

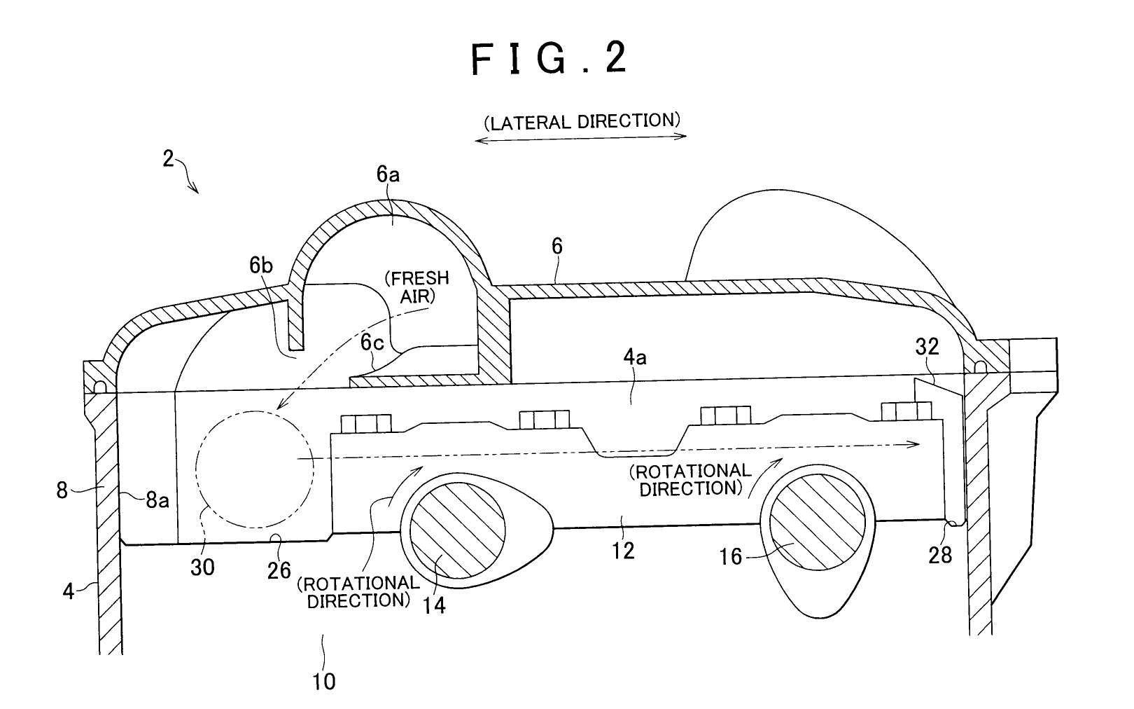

FIG. 1 is a plan view showing an overall construction of a cylinder head 4 for an internal combustion engine 2 according to the first embodiment of the invention. FIG. 2 is a cross-sectional view taken along a line X-X of FIG. 1. The cross-sectional view of FIG. 2 shows a state in which a head cover 6 is mounted. Arrows indicated by alternate long and two short dashes lines represent the flow of gas. In the other drawings as well, arrows indicated by alternate long and two short dashes lines represent the flow of gas.

Five journal bearings 10 are formed in the cylinder head 4 inside a deck portion 8 that surrounds the outer periphery of the cylinder head 4. An intake camshaft 14 and an exhaust camshaft 16 are rotatably supported by fastening five cam caps 12 by means of boltscamshaft.

The internal combustion engine 2 may be a four-cylinder gasoline engine or a four-cylinder diesel engine. In the direction in which respective cylinders 18, 20, 22, and 24 are arranged, a journal bearing 10 is provided between the cylinders 18 and 20, between the cylinders 20 and 22, between the cylinders 22 and 24, and beside each of the outer cylinders. The five cam caps 12 are mounted accordingly.

A wider clearance 26 is formed between each of the cam caps 12 and the deck portion 8 on the intake camshaft 14 side than between each of the cam caps 12 and the deck portion 8 on the intake cam shaft 14 side according to the related art. The width of the clearance between each of the cam caps and the deck portion on the intake camshaft side in the related art takes a molding error of the cylinder head 4 at the time of casting or the like into account and hence is extremely narrow, as is the case with a clearance 28 shown on the exhaust camshaft 16 side in the first embodiment of the invention. The wide clearance 26 is about three to six times wider than the narrow clearance 28, and is formed on the intake camshaft 14 side of all the cam caps 12. Thus, a gas flow passage space 30 extending continuously along an entire length in a longitudinal direction (a direction in which the cylinders 18 to 24 are arranged) is formed in the covered space 4a above the cylinder head 4 covered by the head cover 6.

An air (fresh air) introduction channel 6a for introducing as fresh air the atmosphere introduced via an air filter is formed in the head cover 6. The fresh air introduction channel 6a has a meandering shape in the head cover 6. Fresh air is directed from a fresh air introduction port 6b into the covered space 4a above the cylinder head 4 covered with the head cover 6. The fresh air introduction port 6b is oriented toward an upper face of the cylinder head 4, and toward a fresh air introduction position 30a as one location in the gas flow passage space 30. However, in this embodiment of the invention, as shown in FIG. 2, the inflow direction of fresh air directed through the fresh air introduction port 6b into the covered space 4a above the cylinder head 4 is not perpendicular to the upper face of the cylinder head 4 but may be inclined with respect to the cylinder head 4 by the induction face 6c, formed on the fresh air introduction port 6b. Thus, the inflow direction of fresh air is oriented toward one end (the inner face 8a side of the deck portion 8 shown in the drawings) in a lateral direction of the engine (i.e., a direction perpendicular to the direction in which the cylinders 18 to 24 are arranged).

Accordingly, fresh air collides with the inner face 8a of the deck portion 8 as well as the upper face of the cylinder head 4 at the fresh air introduction position 30a. The fresh air then whirls toward the gas flow passage space 30, and flows in a direction along the gas flow passage space 30. That is, most fresh air flows along the gas flow passage space 30, and the amount of fresh air flowing from the fresh air introduction position 30a to the intake camshaft 14 side in the lateral direction of the engine is not large.

The flow of fresh air in the direction along the gas flow passage space 30 is the flow of fresh air in the gas flow passage space 30, which exhibits particularly low flow resistance. Therefore, fresh air quickly spreads through the entire gas flow passage space 30. Fresh air that has quickly spread in the entire gas flow passage space 30 flows substantially parallel to the journal bearings 10 and the cam caps 12. The flow resistance of this flow is higher than the flow resistance of the flow of fresh air in the direction along the gas flow passage space 30, due to a structure formed on the intake camshaft 14, the exhaust camshaft 16, and the upper face of the cylinder head 4.

After that, fresh air is sucked into a fresh air discharge port 32 as a fresh air discharge position located opposite the gas flow passage space 30 in the lateral direction. The fresh air discharge port 32 penetrates the cylinder block from the cylinder head 4, and discharges fresh air into a crank case located below the cylinder block. Fresh air is thereafter returned to an intake pipe via a blow-by gas reduction device (PCV).

Blow-by gas that has flowed into the covered space 4a above the cylinder head 4 as described above (e.g., blow-by gas that has flowed into the covered space 4a from a chain cover side) can be discharged to the fresh air discharge port 32 due to the flow of fresh air. A baffle plate may be arranged between the fresh air discharge port 32 and the exhaust camshaft 16 to prevent oil mist generated during rotation of the exhaust camshaft 16 from directly entering the fresh air discharge port 32.

The following effects are obtained according to the first embodiment of the invention described above. First, the gas flow passage space 30 is continuously formed above the cylinder head 4 over the entire length from the fresh air introduction position 30a in the longitudinal direction of the covered space 4a above the cylinder head 4. In this case, the gas flow passage space 30 is formed at one end in the lateral direction of the engine. Thus, fresh air directed into the covered space 4a above the cylinder head 4 immediately and quickly flows through the gas flow passage space 30, which exhibits low flow resistance, and uniformly spreads through the entire gas flow passage space 30 in the longitudinal direction of the engine. Thereafter, although no special space for the passage of gas flow is set in the lateral direction from this gas flow passage space 30, fresh air flows over the various components arranged or formed on the surface of the cylinder head (the intake camshaft 14, the exhaust camshaft 16, valve stems, ignition plugs in the case of a gasoline engine, fuel injection valves in the case of a diesel engine, and the like). Fresh air is eventually discharged to the outside of the covered space 4a through the fresh air discharge port 32, which is arranged at a position other than the gas flow passage space 30. In this particular case, the fresh air discharge port 32 is provided at the end opposite the gas flow passage space 30 in the lateral direction.

As described above, fresh air first spreads uniformly in the gas flow passage space 30, which exhibits particularly low flow resistance, and then starts flowing out from the entire gas flow passage space 30 to spaces in other regions. In this case, fresh air flows in the lateral direction and hence covers a relatively short distance to flow through the entire covered space 4a above the cylinder head 4. Thus, fresh air spreads to corner portions 4b, 4c, and 4d of the covered space 4a and the like as well and can be prevented from stagnating. Especially in the corner portion 4b, according to the construction of the related art, fresh air is blocked from flowing by the journal bearings 10 and the cam caps 12 and hence tends to stagnate, and high-concentration blow-by gas is likely to be accumulated. However, in this embodiment of the invention, this accumulation of high-concentration blow-by gas is prevented.

Further, the fresh air discharge port 32 is located at the end opposite the gas flow passage space 30 in the lateral direction. Thus, the flow of fresh air sufficiently spreads throughout the entire covered space 4a and before reaching the fresh air discharge port 32. Therefore, fresh air is more effectively prevented from stagnating in the corner portions 4b, 4c, and 4d and the like.

By taking the flow passage of fresh air into account as described above, fresh air may be uniformly spread in the covered space 4a above the cylinder head 4 covered with the head cover 6. Accordingly, no region where the concentration of blow-by gas is enhanced, due to the stagnation of gas flow, is created. Therefore, degradation of the lubricating oil flowing on the cylinder head 4 may be prevented.

Further, the gas flow passage space 30 is formed by the width of the cam caps 12 smaller than the length of the cylinder head 4 in the lateral direction and hence increasing the covered space 4a above the cylinder head 4. Thus, the gas flow passage space 30 may be easily formed.

Further, fresh air is blown at the fresh air introduction position 30a provided at one end of the gas flow passage space 30 from the fresh air introduction port 6b, and the direction in which fresh air is blown is inclined toward the end side in the lateral direction. Thus, fresh air is restrained from flowing from the fresh air introduction position 30a in the lateral direction. Instead, the fresh air flows toward the entire gas flow passage space 30, and spreads in the entire gas flow passage space 30 without losing momentum. Accordingly, fresh air can be uniformly spread through the entire covered space 4a above the cylinder head 4 more reliably.

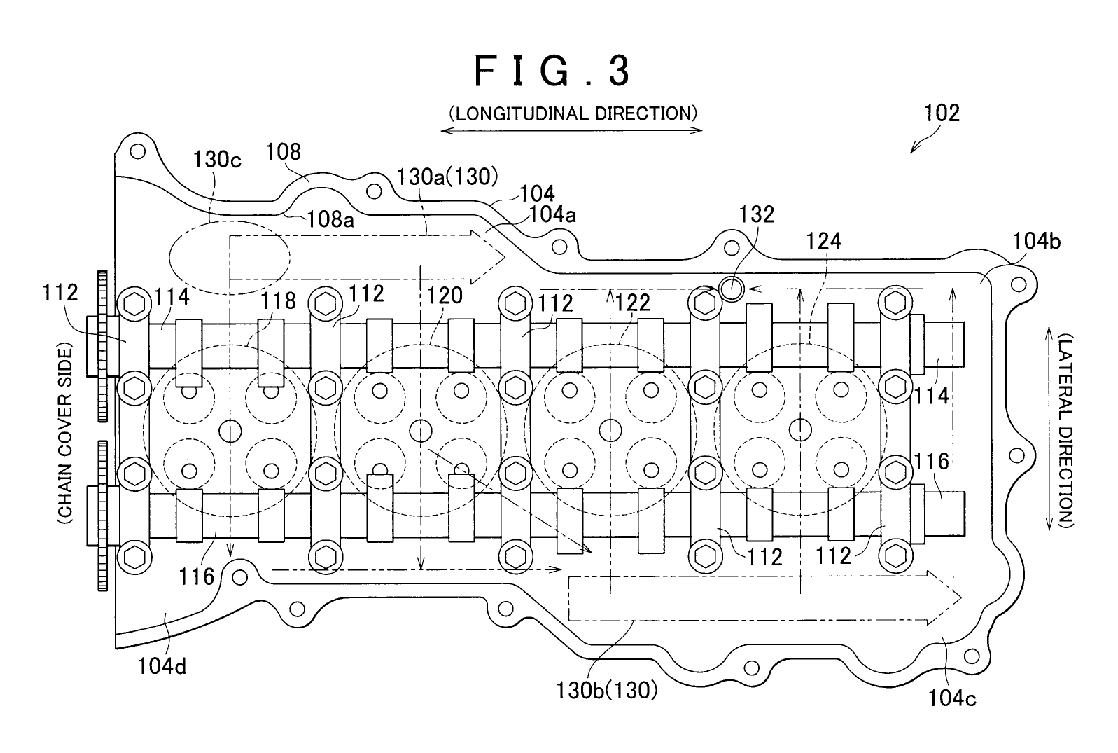

In an internal combustion engine 102 according to the second embodiment of the invention, as shown in a plan view of FIG. 3, two partial gas flow passage spaces 130a and 130b are formed in a covered space 104a above a cylinder head 104. The two partial gas flow passage spaces 130a and 130b together form a gas flow passage space 130 extending from a fresh air introduction position 130c over the entire length in the longitudinal direction of the covered space 104a. However, the two partial gas flow passage spaces 130a and 130b are spaced apart from each other in the lateral direction, so that the gas flow passage space 130 is discontinuous.

The partial gas flow passage space 130b is the downstream region of the gas flow passage space 130 and is arranged near the exhaust camshaft 116. Therefore, the fresh air discharge port 132 is formed at the end opposite the partial gas flow passage space 130b in the lateral direction.

The head cover corresponds in shape to the cylinder head 104, but is basically identical in construction to that of the first embodiment of the invention. That is, the direction of fresh air directed from the fresh air introduction port into the covered space 104a above the cylinder head 104 is inclined, and hence is oriented toward the end side in the lateral direction where the partial gas flow passage space 130a is arranged (in a direction perpendicular to the direction in which the cylinders 118 to 124 are arranged).

Accordingly, at the fresh air introduction position 130c set in the partial gas flow passage space 130a located upstream in the partial gas flow area 130a, as in the first embodiment of the invention, fresh air collides with the inner face 108a of a deck portion 108 as well as the upper face of the cylinder head 104 and then flows along the partial gas flow passage space 130a. In the covered space 104a above the cylinder head 104, the flow of fresh air in the partial gas flow passage space 130a, which exhibits particularly low flow resistance. Therefore, fresh air quickly spreads through the entire partial gas flow passage space 130a.

Fresh air that has quickly spread through the entire partial gas flow passage space 130a flows to the opposite side in the lateral direction along the direction of the journal bearings and the cam caps 112. The flow resistance in this direction is higher than the flow resistance of fresh air flowing along the partial gas flow passage space 130a, due to the components formed on the intake camshaft 114, the exhaust camshaft 116, and the upper face of the cylinder head 104.

After that, fresh air mainly flows toward the partial gas flow passage space 130b, where flow resistance is relatively low, downstream of the covered space 104a above the cylinder head 104. Thus, fresh air quickly spreads to the corner portion 104c, located at a most downstream position in the partial gas flow passage space 130b.

After that, fresh air flows to the side opposite the gas flow passage space 30 in the lateral direction of the engine, and is sucked into the fresh air discharge port 132 as the fresh air discharge position. Thus, fresh air is discharged from the fresh air discharge port 132 into the crank case located below the cylinder block. Fresh air is thereafter returned to the intake pipe via the PCV.

Blow-by gas that has flowed into the covered space 104a above the cylinder head 104 can be discharged to the fresh air discharge port 132 due to the flow of fresh air as described above. A baffle plate may be arranged between the fresh air discharge port 132 and the intake camshaft 114 to prevent an oil mist generated during rotation of the intake camshaft 114 from directly entering the fresh air discharge port 132.

The second embodiment of the invention is identical in other constructional details to the first embodiment of the invention. According to the second embodiment of the invention described above, the following effects are obtained. First, due to a problem in designing the internal combustion engine 102, it is impossible to arrange the fresh air introduction position 130c and the fresh air discharge port 132 opposite each other in the lateral direction.

In the second embodiment of the invention, the gas flow passage space 130 extending from the fresh air introduction position 130c over the entire length in the longitudinal direction of the covered space 104a is divided into the two partial gas flow passage spaces 130a and 130b, and is formed as the discontinuous gas flow passage space 130 separated in the lateral direction. Thus, the fresh air introduction position 130c and the fresh air discharge port 132 may be arranged on the same side in the lateral direction. In addition, air is sufficiently spread in the respective corners 104b, 104c, and 104d.

Accordingly, the effects of the first embodiment of the invention can be created without reducing the degree of freedom in designing the internal combustion engine 102. Further, the fresh air discharge port 132 can be arranged in the vicinity of the corner portion 104b where fresh air is particularly likely to stagnate. Therefore, blow-by gas is more reliably discharged, and the accumulation of high-concentration blow-by gas is prevented.

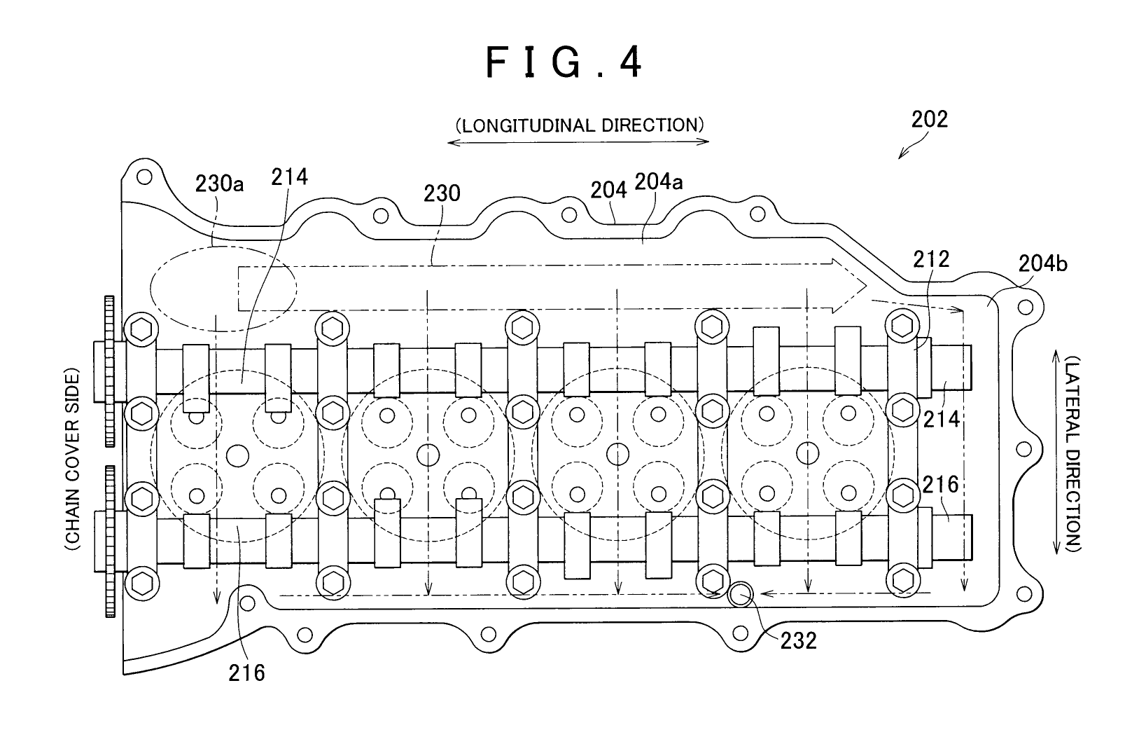

In an internal combustion engine 202 according to the third embodiment of the invention, as shown in a plan view of FIG. 4, a gas flow passage space 230 is provided in a covered space 204a above a cylinder head 204 at an end on an intake camshaft 214 side in a lateral direction, and a fresh air discharge port 232 is provided at an end on an exhaust camshaft 216 side, as in the first embodiment of the invention. However, the gas flow passage space 230 extends only to the rightmost cam cap 212 (on the rear side of the internal combustion engine) instead of extending over the entire length in a longitudinal direction of the covered space 204a. That is, in the covered space 204a above the cylinder head 204, the gas flow passage space 230 is formed continuously from a fresh air introduction position 230a substantially over the entire length in the longitudinal direction of the covered space 204a above the cylinder head 204. The head cover is so formed as to correspond in shape to the cylinder head 204.

In this construction as well, the distance from the gas flow passage space 230 to a corner portion 204b where fresh air is likely to stagnate is short. Therefore, fresh air that has quickly reached the rightmost cam cap 212 in the gas flow passage space 230 sufficiently flows into the corner portion 204b.

The third embodiment of the invention is otherwise structurally identical to the first embodiment of the invention. According to the third embodiment of the invention described above as well, the effects similar to those of the first embodiment of the invention can be created.

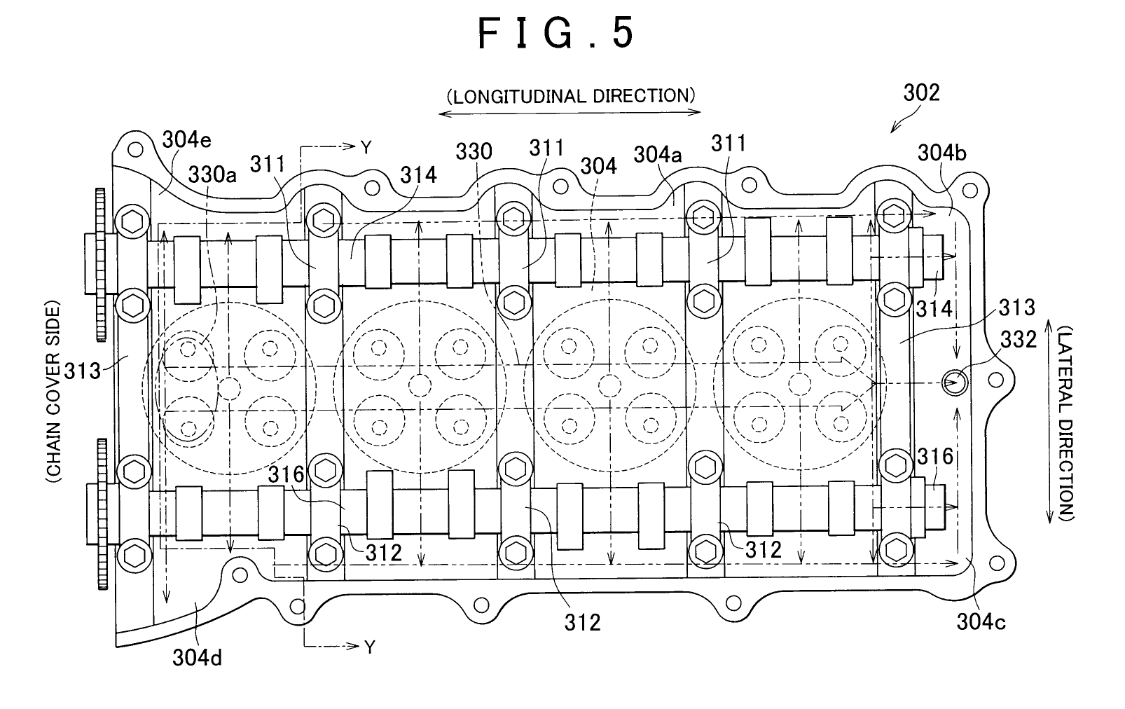

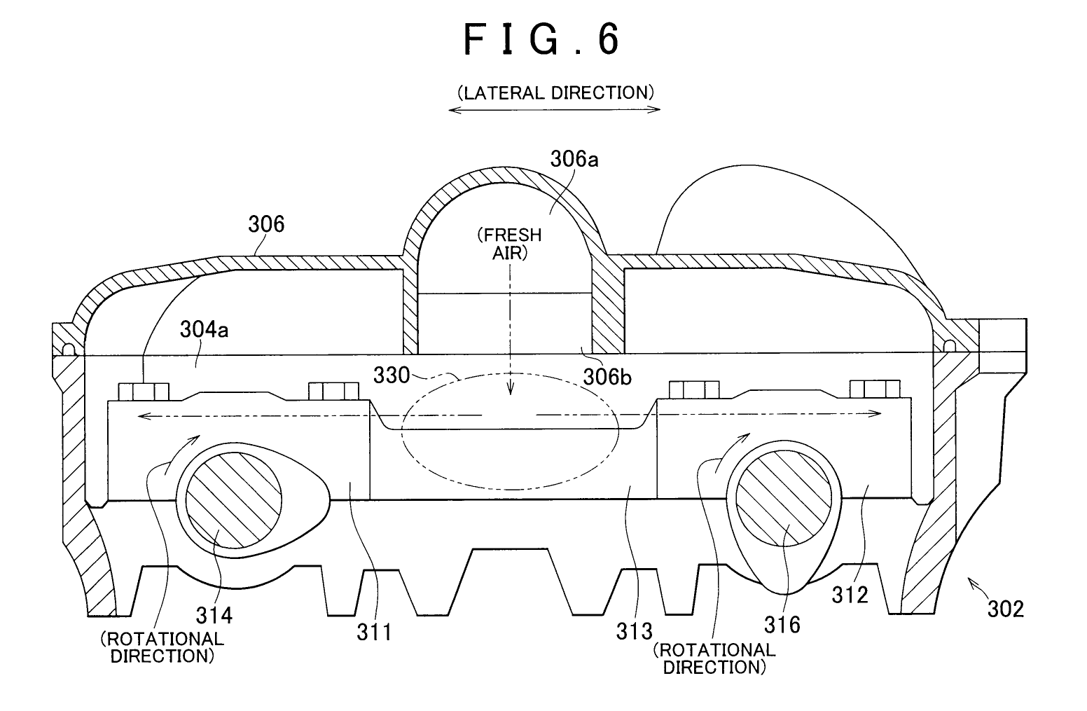

The fourth embodiment of the invention shows an example of a cam carrier 302 arranged between a head cover 306 and the cylinder head 304 of an internal combustion engine as shown in FIGS. 5 and 6. FIG. 5 is a plan view showing an overall construction of the cam carrier 302. FIG. 6 is a cross-sectional view taken along a line Y-Y of FIG. 5.

The cam carrier 302 is arranged on the cylinder head 304 and covered by the head cover 306 to form a covered space 304a above the cylinder head 304. In this covered space 304a, a gas flow passage space 330 extending continuously from a fresh air introduction position 330a substantially over an entire length in a longitudinal direction of the covered space 304a is formed between an intake camshaft 314 and an exhaust camshaft 316. [0047] The gas flow passage space 330 is formed through the separation of cam caps 311 on the intake camshaft 314 from cam caps 312 on the exhaust camshaft 316. That is, the sum of the width of the cam caps 311 and the width of the cam caps 312 is sufficiently smaller than the width of the covered space 304a in the lateral direction, so that the region between the intake camshaft 314 and the exhaust camshaft 316 is formed as a series of open spaces. It should be noted that two cam caps 313 at both ends in an anteroposterior (longitudinal) direction are common to the intake camshaft 314 and the exhaust camshaft 316. Accordingly, the gas flow passage space 330 extending substantially over the entire length in the longitudinal direction is formed between the two cam caps 313 at both the ends.

The fresh air introduction position 330a is set at one end of the gas flow passage space 330 in the longitudinal direction. In the fourth embodiment of the invention, the fresh air introduction position 330a is set at the front end (on the left side in FIG. 5). Fresh air that has flowed past a fresh air introduction channel 306a in the head cover 306 is blown out from a fresh air introduction port 306b toward the fresh air introduction position 330a. An induction face of the fresh air introduction port 306b is formed such that the direction in which fresh air is blown out from this fresh air introduction port 306b is perpendicular to or diagonally backward with respect to an upper face of the cylinder head 304.

The fresh air discharge port 332 is provided outside the gas flow passage space 330 across the rear one (on the right side in FIG. 5) of the cam caps 313, namely, behind the rear one of the cam caps 313. Accordingly, fresh air that has been blown out from the fresh air introduction port 306b and collided with the upper face of the cylinder head 304 at the fresh air introduction position 330a flows backward along the gas flow passage space 330. The flow of fresh air is the flow of fresh air in the gas flow passage space 330, which exhibits particularly low flow resistance, in the covered space 304a above the cylinder head 304. Therefore, fresh air quickly spreads throughout the entire gas flow passage space 330.

Fresh air that has quickly spread in the entire gas flow passage space 330 flows to a space outside the intake camshaft 314 and the exhaust camshaft 316, and then flows beyond the rear one of the cam caps 313. Thus, fresh air also spreads to all corner portions 304b, 304c, 304d, and 304e under the covered space 304a.

Fresh air is then sucked into the fresh air discharge port 332. Thus, fresh air is discharged from the fresh air discharge port 332 into the crank case located below the cylinder block, and is thereafter returned to the intake pipe via the PCV.

Blow-by gas that has flowed into the covered space 304a above the cylinder head 304 may be discharged to the fresh air discharge port 332 due to the flow of fresh air as described above. A baffle plate may be provided between the fresh air discharge port 332 and the camshafts 314 and 316 to prevent an oil mist generated during rotation of the camshafts 314 and 316 from directly entering the fresh air discharge port 332.

In the fourth embodiment of the invention described above, the following effects are obtained. First, in the fourth embodiment of the invention, the gas flow passage space 330 is formed at a center in the lateral direction, and fresh air is directed from the fresh air introduction position 330a and hence quickly spreads throughout the entire gas flow passage space 330. Therefore, fresh air is sufficiently spread to the respective corner portions 304b to 304e without stagnating. Accordingly, the effects of the first embodiment of the invention can be created.

Further, when fresh air is blown out diagonally backward (on the right side in FIG. 5), fresh air is especially restrained from flowing in the lateral direction, and spreads through the entire gas flow passage space 330 without losing momentum. As a result, fresh air may be spread more uniformly through the entire covered space 304a above the cylinder head 304.

Further, even if the gas flow passage space 330 is formed in the cam carrier 302, an increase in width in the lateral direction may be absorbed to a certain extent in the cam carrier 302. Accordingly, the width in the lateral direction may be restrained from increasing on the cylinder head 304 side.

In each first second and third embodiments of the invention, the gas flow passage space is formed directly above the cylinder head. However, as indicated by the fourth embodiment of the invention, it is acceptable to adopt a construction in which the gas flow passage space is formed in a cam carrier and hence in a space above a cylinder head.

In this case as well, the effects of the fourth embodiment of the invention may be obtained. Further, in the first embodiment of the invention, as shown in FIG. 2, the direction in which fresh air introduced from the fresh air introduction channel 6a is discharged from the fresh air introduction port 6b is oriented toward the end in the lateral direction on the side where the gas flow passage space 30 exists, by the induction face 6c. Instead of this construction, fresh air may be discharged toward the corner portion 4b located behind the gas flow passage space 30 (on the right side in FIG. 1) at the fresh air introduction position 30a of the gas flow passage space 30. With this momentum, fresh air spreads in the entire gas flow passage space 30, including the corner portion 4b, more reliably, and high-concentration blow-by gas can be prevented from being accumulated.

Further, in the second embodiment of the invention, as shown in FIG. 3, the partial gas flow passage space 130a extending continuously from the first cylinder 118 to the second cylinder 120 and the partial gas flow passage space 130b extending continuously from the third cylinder 122 to the fourth cylinder 124 are formed. It is appropriate to form the entire gas flow passage space substantially along the entire length of the engine in the longitudinal direction. Therefore, it is also appropriate to provide partial gas flow passage spaces each cylinder, and to arrange these four partial gas flow passage spaces alternately at different ends in the lateral direction.

Further, in the first embodiment of the invention, the gas flow passage space 30 is provided at that one of the ends in the lateral direction which is located near the intake camshaft 14. Alternatively, the gas flow passage space 30 may be provided at the end near the exhaust camshaft 16. In this case, the fresh air discharge port 32 is provided on the intake camshaft 14 side.

Further, fresh air need not be directly discharged from the covered space but may be discharged through a discharge passage formed in the head cover. In this case, the degree of freedom for locating the fresh air discharge position is enhanced, and the degrees of freedom of the shape and arrangement of the gas flow passage space are also enhanced correspondingly.

Further, the internal combustion engine according to each embodiment of the invention is a four-cylinder gasoline engine or a four-cylinder diesel engine, but may be an internal combustion engine having any number of cylinders.

While the invention has been described with reference to the example embodiments thereof, it should be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the spirit and scope of the invention.

What is claimed is:

1. A cylinder head structure for an internal combustion engine that directs air into a covered space above a cylinder head covered by a head cover to ventilate the covered space, the cylinder head structure comprising:
a gas flow passage space, formed in the covered space, that extends continuously over an entire length or substantially over the entire length of the cylinder head in a longitudinal direction of the cylinder head,
an air introduction position, formed in the gas flow passage space, and
an air discharge position, formed outside of the gas flow passage space.

2. The cylinder head structure for the internal combustion engine according to claim 1, wherein the gas flow passage space is formed at one end in a lateral direction in the covered space.

3. The cylinder head structure for the internal combustion engine according to claim 2, wherein the air discharge position is arranged at an end opposite the gas flow passage space in the lateral direction in the covered space.

4. The cylinder head structure for the internal combustion engine according to claim 2, wherein the air introduction position is located such that air flows through the air introduction position in a direction inclined with respect to an upper face of the cylinder head and hence oriented toward an end side in a lateral direction where the gas flow passage space is formed.

5. The cylinder head structure for the internal combustion engine according to claim 3, wherein the air introduction position is located such that air flows through the air introduction position in a direction inclined with respect to an upper face of the cylinder head and hence oriented toward an end side in a lateral direction where the gas flow passage space is formed.

6. A cylinder head structure for an internal combustion engine that directs air into a covered space above a cylinder head covered by a head cover to ventilate the covered space, the cylinder head structure comprising:
a gas flow passage space, formed in the covered space, that extends discontinuously in a lateral direction and over an entire length or substantially over the entire length of the cylinder head in a longitudinal direction of the cylinder head,
an air introduction position, formed in the gas flow passage space, and
an air discharge position, formed outside of the gas flow passage space.

7. The cylinder head structure for the internal combustion engine according to claim 6, wherein the gas flow passage space is alternately and discontinuously arranged at different ends in the lateral direction in the covered space.

8. The cylinder head structure for the internal combustion engine according to claim 1, wherein the longitudinal direction in the covered space is a direction in which a plurality of cylinders are arranged.

9. The cylinder head structure for the internal combustion engine according to claim 8, wherein a camshaft arranged on the cylinder head, and the camshaft is held by a cam cap having a width smaller than the width of the covered space in the lateral direction so that the covered space is opened to form the gas flow passage space.

10. The cylinder head structure for the internal combustion engine according to claim 6, wherein the longitudinal direction in the covered space is a direction in which a plurality of cylinders are arranged.

11. The cylinder head structure for the internal combustion engine according to claim 10, wherein a camshaft is arranged on the cylinder head, and the camshaft is held by a cam cap having a width smaller than the width of the covered space in the lateral direction so that the covered space is opened to form the gas flow passage space.

12. The cylinder head structure for the internal combustion engine according to claim 1, wherein the air introduction position is a position at which air is blown from an air introduction port formed through the head cover.

13. The cylinder head structure for the internal combustion engine according to claim 6, wherein the air introduction position is a position at which air is blown from an air introduction port formed through the head cover.

14. The cylinder head structure for the internal combustion engine according to claim 1, wherein the air introduction position is set such that air flows through the air introduction position in a direction inclined with respect to a flow direction of air with respect to an upper face of the cylinder head.

15. The cylinder head structure for the internal combustion engine according to claim 6, wherein the air introduction position is set such that air flows through the air introduction position in a direction inclined with respect to a flow direction of air with respect to an upper face of the cylinder head.

16. The cylinder head structure for the internal combustion engine according to claim 1, wherein the air introduction position is provided at one end of the gas flow passage space.

17. The cylinder head structure for the internal combustion engine according to claim 6, wherein the air introduction position is provided at one end of the gas flow passage space.

18. The cylinder head structure for the internal combustion engine according to claim 1, wherein the covered space is formed by covering the cylinder head with the head cover via a cam carrier, and
the gas flow passage space is at least partially formed in a space surrounded by the cam carrier.

19. The cylinder head structure for the internal combustion engine according to claim 6, wherein the covered space is formed by covering the cylinder head with the head cover via a cam carrier, and
the gas flow passage space is at least partially formed in a space surrounded by the cam carrier.

20. A cylinder head structure for an internal combustion engine that directs air into a covered space above a cylinder head covered by a head cover to ventilate the covered space, the cylinder head structure comprising:
a gas flow channel, formed in the covered space, that extends continuously over an entire length or substantially over the entire length of the cylinder head in a longitudinal direction of the cylinder head;
an air introduction portion formed in the gas flow channel; and
an air discharge portion formed outside of the gas flow channel.

21. A cylinder head structure for an internal combustion engine that directs air into a covered space above a cylinder head covered by a head cover to ventilate the covered space, the cylinder head structure comprising:
a gas flow channel, formed in the covered space, that extends discontinuously in a lateral direction and over an entire length or substantially over the entire length of the cylinder head in a longitudinal direction of the cylinder head;
an air introduction portion formed in the gas flow channel; and
an air discharge portion formed outside of the gas flow channel.
